(19) United States
(12) Patent Application Publication
(10) Pub. No.: US 2012/0294130 A1
(43) Pub. Date: Nov. 22, 2012

(54) DATA STORAGE DEVICE

(75) Inventors: Kazuo Watabe, Yokohama-shi (JP); Akihito Ogawa, Fujisawa-shi (JP); Hideaki Okano, Yokohama-shi (JP); Takashi Usui, Saitama-shi (JP)

(73) Assignee: KABUSHIKI KAISHA TOSHIBA, Tokyo (JP)

(21) Appl. No.: 13/478,441

(22) Filed: May 23, 2012

Related U.S. Application Data
(63) Continuation of application No. PCT/JP2009/069810, filed on Nov. 24, 2009.

(51) Int. Cl. G11B 21/02; G11B 7/1359; G11B 7/1353

(52) U.S. Cl. 369/44.33; G9B/21.003; G9B/7.113; G9B/7.115

(57) ABSTRACT

According to one embodiment, a data storage device includes a data recording medium, a light source, and following units. The light application unit splits the laser beam from the light source, and applies the first and second light beams to the data recording medium from different directions. The light detection unit detects reflected light beams from the data recording medium. The light deflection unit deflects the reflected light beams to direct the reflected light beams to the light detection unit. The arithmetic unit calculates positional error information based on the detection signal. The drive unit displaces a position and a posture of the data recording medium based on the positional error information.

### CROSS-REFERENCE TO RELATED APPLICATIONS

This application is a Continuation Application of PCT Application No. PCT/JP2009/069810, filed Nov. 24, 2009, the entire contents of which are incorporated herein by reference.

### FIELD

Embodiments described herein relate generally to a data storage device.

### BACKGROUND

One known data storage device capable of recording a large volume of data, such as high-density images, is, for example, a holographic storage device. The holographic storage device is attracting attention as the next-generation recording medium because it records data in the form of a hologram into a holographic storage medium capable of recording a large volume of data.

In such a holographic storage device, the three-dimensional position and posture (angle) of a holographic storage medium need to be controlled strictly in recording data and in reproducing data. As one example of a device that controls the posture of a medium, US2006/0279824 discloses a holographic storage device which irradiates a holographic storage medium with a single laser beam from a light source and detects its reflected light beam, thereby detecting the angle of the medium. In addition, this holographic storage device records a vibration detection hologram pattern in a holographic storage medium in advance and causes a diffraction pattern detector to detect an interference fringe of diffraction patterns reproduced as a result of irradiating the holographic storage device with light beams from two light sources, thereby detecting the vibration of the medium.

However, the technique for detecting the angle of a holographic storage medium disclosed in US2006/0279824 is to just apply an angle sensor using an ordinary laser or LED light beam to a holographic storage medium. Therefore, error information on a plurality of control axis positions cannot be acquired from the angle sensor written in US2006/0279824. In addition, the technique for recording a vibration detection hologram pattern into a holographic storage medium in advance can be used to detect the vibration of a medium, but cannot to perform three-dimensional positional control.

### BRIEF DESCRIPTION OF THE DRAWINGS

FIG. 1A is a block diagram of a data storage device according to a first embodiment, showing a light beam trajectory in recording data;

FIG. 1B is a block diagram showing a light beam trajectory related to the data recording medium shown in FIG. 1A;

FIG. 2A is a block diagram showing a light beam trajectory in reproducing data in the data storage device of FIG. 1A;

FIG. 2B is a block diagram showing a light beam trajectory related to the data recording medium shown in FIG. 2A;

FIG. 3 is a sectional view schematically showing a structure of the data recording medium shown in FIG. 1A;

FIG. 4 is a schematic diagram showing trajectories of reflected light beams reflected by servo marks formed in the data recording medium of FIG. 3;

FIG. 5 is a schematic diagram showing an example of arranging a prism as a light deflection element in an optical system that detects reflected light beams shown in FIG. 4;

FIG. 6 is a schematic diagram showing a diffraction element as another example of the light deflection element shown in FIG. 4;

FIG. 7A shows reflected spot images detected by a photodetector when the data recording medium of FIG. 1 is displaced in an x-direction;

FIG. 7B is a graph showing the relationship between the displacement amount by which the data recording medium of FIG. 1 is displaced from the initial position in the x-direction and the calculation result of positional error information in the x-direction;

FIG. 8A shows reflected spot images detected by a photodetector when the data recording medium of FIG. 1 is shifted in a y-direction;

FIG. 8B is a graph showing the relationship between the displacement amount by which the data recording medium of FIG. 1 is displaced from the initial position in the y-direction and the calculation result of positional error information in the y-direction;

FIG. 9A shows reflected spot images detected by a photodetector when the data recording medium of FIG. 1 is displaced in a z-direction;

FIG. 9B is a graph showing the relationship between the displacement amount by which the data recording medium of FIG. 1 is displaced from the initial position in the z-direction and the calculation result of positional error information in the z-direction;

FIG. 10A shows reflected spot images detected by a photodetector when the data recording medium of FIG. 1 is rotated in a By direction;

FIG. 10B is a graph showing the relationship between the angle through which the data recording medium of FIG. 1 is rotated from the initial position in the By direction and the calculation result of positional error information in the θy direction; and

FIG. 11 is a block diagram of a data storage device according to a second embodiment, showing an optical system used in reproducing data.

### DETAILED DESCRIPTION

In general, according to one embodiment, a data storage device includes a data recording medium, a first light source, a light application unit, a light detection unit, a light deflection unit, a arithmetic unit, and drive unit. The first light source is configured to generate a first laser beam. The light application unit is configured to split the first laser beam into a first light beam and a second light beam, and apply the first light beam and the second light beam to the data recording medium from different directions. The light detection unit is configured to detect reflected light beams to generate a detection signal, the reflected light beams corresponding to the first light beam and the second light beam reflected by the data recording medium. The light deflection unit is arranged in optical paths of the reflected light beams from the data recording medium to the light detection unit, and configured to deflect the reflected light beams to direct the reflected light beams to the light detection unit. The arithmetic unit is configured to calculate positional error information indicating a relative position and posture of the data recording medium with respect to a target position and posture based on the detection signal. The drive unit is configured to displace a position and a posture of the data recording medium based on the positional error information.

The embodiments provide data storage devices capable of performing high-accuracy three-dimensional positional control by detecting three-dimensional positional information on a data recording medium and controlling the position of the data recording medium based on the positional information.

Hereinafter, data storage devices according to embodiments will be described with reference to the accompanying drawings.

### First Embodiment

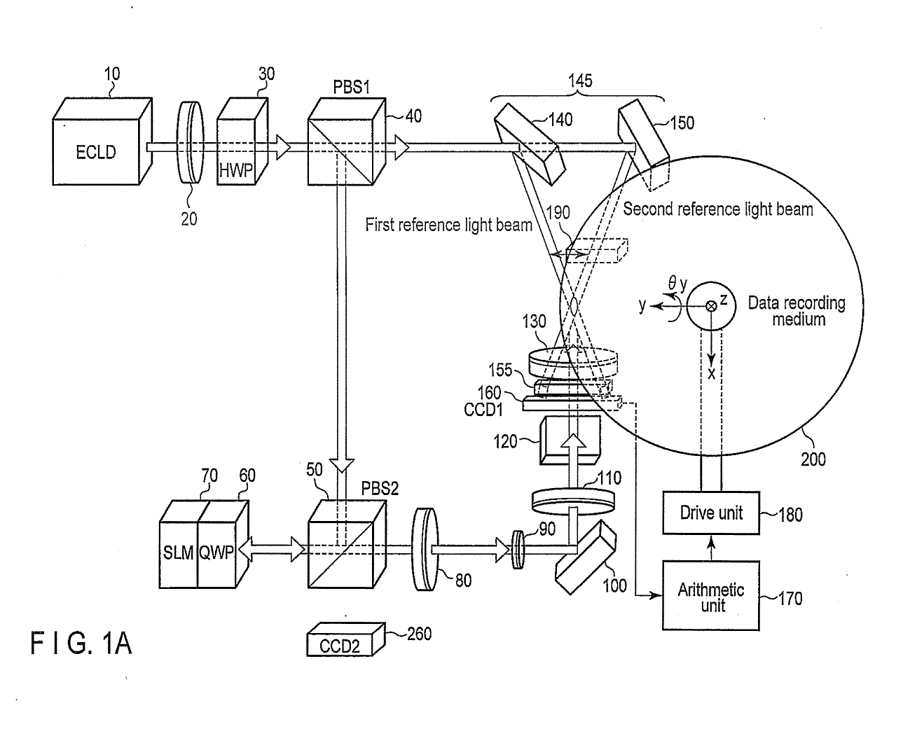

FIG. 1A schematically shows an optical system used in recording data in a data storage device according to a first embodiment. FIG. 1B shows a trajectory of a light beam related to a data recording medium 200 shown in FIG. 1A. The data storage device includes a holographic storage medium corresponding to the data recording medium 200 as shown in FIG. 1A. The holographic storage medium is formed in, for example, a discoid shape. The data recording medium 200 is supported by a drive unit 180 so as to be capable of moving in the three-dimensional direction and rotating (e.g., about a y-axis). As explained later, the data recording medium is displaced to a target three-dimensional position and posture (angle) according to positional error information from an arithmetic unit (also referred to as an arithmetic circuit) 170.

The data storage device of FIG. 1A includes a light source 10 that generates a coherent light beam. The light beam generated by the light source 10 is directed to a collimator lens 20. In the first embodiment, the light source 10 is an exterior resonance semiconductor laser (ECLD) that generates laser beam. The laser beam generated by the light source 10 is collimated or shaped into parallel light by the collimator lens, passes through a λ/2 plate (also referred to as a half-wave plate [HWP]) 30, and enters a polarization beam splitter (PBS1) 40. The λ/2 plate 30 changes the polarization direction of the incident laser beam. The polarization beam splitter 40 splits the incident laser beam into a data light beam and a reference light beam. Specifically, an S-polarized component of the laser beam passing through the λ/2 plate 30 is reflected by the reflecting surface of the polarization beam splitter 40, directed as a data light beam toward a polarization beam splitter (PBS2) 50. A P-polarized component of the laser beam passes through the polarization beam splitter 40 and is directed toward a half-mirror 140.

The data light beam from the polarization beam splitter 40 is reflected by the reflecting surface of the polarization beam splitter 50, passes through a λ/4 plate 60, and enters a spatial light modulator (SLM) 70. The spatial light modulator 70 modulates the incident data light beam into page data to be recorded in the data recording medium 200, and reflects the modulated data light toward the λ/4 plate 60. The modulated data light beam passing through the λ/4 plate 60 turns into a data light beam that has a polarization perpendicular to that when entering the polarization beam splitter 50, with the result that the resulting data light beam passes through the polarization beam splitter 50. The modulated data light beam passing through the polarization beam splitter 50 passes through a lens 80, an aperture 90, a mirror 100, a lens 110, and a raising mirror 120 and enters an objective lens 130. The lens 80 condenses a data light beam passing through the polarization beam splitter 50. The aperture 90 controls the spot size of the data light beam on the data recording medium 200 by limiting the passing light beam size near the focal point of the condensed data light beam. The data light beam passing through the aperture 90 is reflected by the mirror 100 toward the lens 110, turned into parallel light, and directed to the objective lens 130 by the mirror 120. The objective lens 130 focuses the data light beam on a recording position in the data recording medium 200.

The reference light beam passing through the polarization beam splitter 40 is split at a specific ratio by a half-mirror 140. The reference light beam reflected by the half-mirror 140 is applied as a first reference light beam at the same position or area as that of the data light beam on the data recording medium 200. The reference light beam passing through the half-mirror 140 is reflected by a mirror 150 and applied as a second reference light beam at the same position as that of the data light beam on the data recording medium 200. The half-mirror 140 and mirror 150 function as an light application unit 145 that splits the incident light beam to produce two segment light beams (i.e., first and second reference light beams) and directs the two segment light beams to the data recording medium 200. Between the light application unit 145 and the data recording medium 200, there is provided a shutter 190. The shutter 190 selectively intercepts either the first or second reference light beam in recording and reproducing data.

In addition, in the first embodiment, the first and second reference light beams (reflected beams) reflected by the data recording medium 200 are deflected in their optical paths by a light deflection element 155 (DFL) and detected by a photodetector (CCD1) 160. The photodetector 160 is, for example, a CCD image sensor, a CMOS image sensor, or the like. The photodetector (also referred to as a light detection unit) 160 detects a reflected light beam and transmits image information as a detection signal to the arithmetic unit 170. The detection signal output by the photodetector 160 can include coordinate information (e.g., two-dimensional coordinates on an s-t plane explained later) on a reflected light beam on the sensor surface (or light detecting surface) of the light detection unit. The arithmetic unit 170 calculates positional error information on the data recording medium 200 based on image information from the photodetector 160. As explained later, the positional error information indicates a relative position and posture of the data recording medium 200 with respect to a target position and posture. The calculated positional error information is transmitted to the drive unit 180. The drive unit 180 drives the data recording medium 200 based on the positional error information, thereby bringing the data recording medium 200 into the correct position and posture.

Next, the operation of recording data on the data recording medium 200 will be explained.

As shown in FIG. 1A, laser beam emitted from the light source 10 enters the collimator lens 20, which collimates the laser beam. The light source 10 is, for example, a semiconductor laser (ECLD) with an external resonator that has a wavelength of 405 nm contained within a blue-violet wavelength range. The collimated laser beam passes through the λ/2 plate 30 and enters the polarization beam splitter 40. The laser beam incident on the polarization beam splitter 40 is split into two routes (a P-polarized component passing through and an S-polarized component being reflected).

The S-polarized component reflected by the polarization beam splitter 40 makes a data light beam used for the recording of the data recording medium 200. The P-polarized component passing through the polarization beam splitter 40 makes a reference light beam used for the recording of the data recording medium 200. The ratio of the light amount of the data light beam to that of the reference light beam can be adjusted by a rotation angle of the λ/2 plate 30.

The data light beam (the light flux split, downward in FIG. 1A) reflected by the polarization beam splitter 40 enters the second polarization beam splitter 50. The data light beam reflected by the polarization beam splitter 50 passes through the λ/4 plate 60, and enters the spatial light modulator 70. The spatial light modulator 70 subjects the wave front of the incident data light beam to modulation corresponding to page data to be recorded on the data recording medium 200 and then reflects the resulting data light beam. As an example, the spatial light modulator 70 is a reflection-type spatial light modulator with a plurality of pixels arranged in rows and columns. In this example, a processing module (not shown) converts data to be recorded on the data recording medium 200 into a page data pattern of two-dimensional image data in an encoding process or the like. This page pattern is provided to the spatial light modulator 70 and then displayed. The spatial light modulator 70 changes the direction of the reflected light beam on a pixel basis or the polarization direction of the reflected light beam on a pixel basis, thereby modulating the data light spatially. In this way, the spatial light modulator 70 gives the data light beam a two-dimensional pattern of data to be recorded.

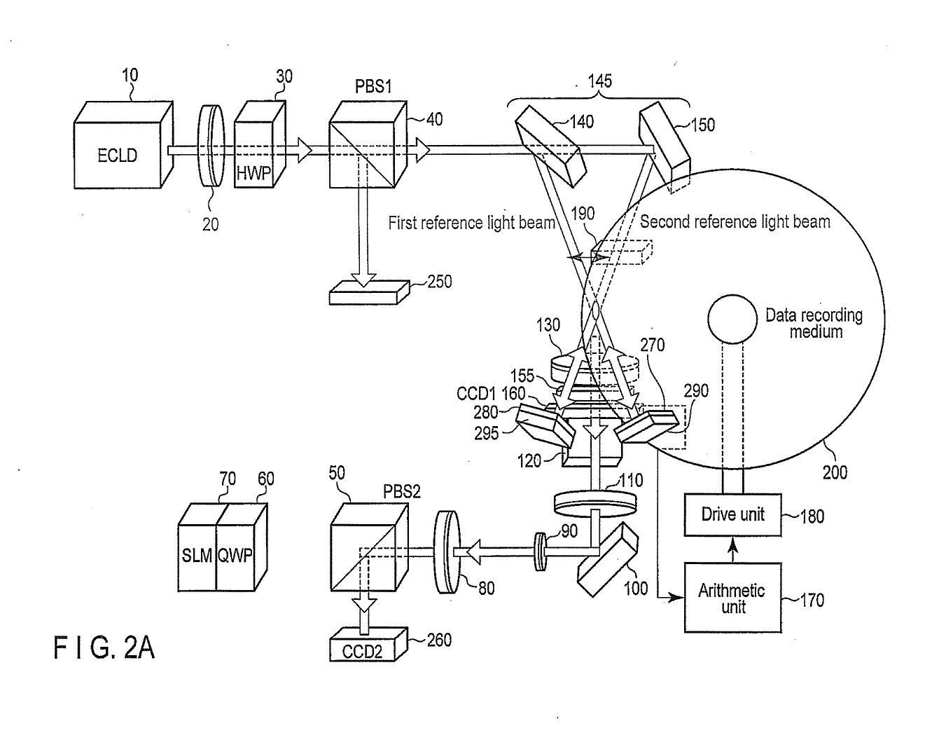

The data light beam modulated at the spatial light modulator 70 is returned to the polarization beam splitter 50 via the λ/4 plate 60. The modulated data light beam passes through the λ/4 plate 60 again, thereby having a polarization perpendicular to that in entering the polarization beam splitter 50, with the result that the modulated data light beam passes through the polarization beam splitter 50. The data light beam passing through the polarization beam splitter 50 is condensed by the lens 80 and enters the lens 110 via the aperture 90 and reflecting mirror 100 arranged near the focal point of the lens 80. The lens 110 turns the data light beam into a parallel beam again. The aperture 90 is an element for limiting the spot size of the data light beam on the data recording medium 200. The data light beam passing through the lens 110 is reflected by the raising mirror 120 obliquely upward with the vertical direction on paper in FIG. 1A as upside, that is, toward the objective lens 130. The objective lens 130 applies a data light beam so that the beam focuses on a recording layer (shown in FIG. 3) in the data recording medium 200.

The reference light beam passing through the polarization beam splitter 40 is split into a second reference light beam passing through the half-mirror 140 and a first reference light beam reflected by the half-mirror 140. The second reference light beam passing through the half-mirror 140 is further reflected by the mirror 150. The shutter 190 intercepts either the first or second reference light beam. The reference light beam not intercepted by the shutter 190 is applied to almost the same position or area as that of the data light beam in the data recording medium 200. Therefore, each of the first and second reference light beams is applied at a different angle to almost the same position in the data recording medium 200 at which the data light beam focuses.

More specifically, when data is recorded on the data recording medium 200, either the first or second reference light beam is always intercepted by the shutter 190. Therefore, in the data recording medium 200, the first reference light beam and data light beam or the second reference light beam and data light beam are applied simultaneously. As a result, in the data recording medium 200, a refractive-index variation corresponding to an interference pattern of the data light beam with the first reference light beam or of the data light beam with the second reference light beam is recorded as page data. With the data storage device shown in FIG. 1A, the first and second reference light beams pass through two optical paths and are applied at different angles on the data recording medium 200, thereby achieving multiple recording of page data at almost same position in the data recording medium 200. In addition to this, the data recording medium 200 is rotated about the y-axis shown in FIG. 1A (thus, performing θy rotation), thereby accomplishing angle-multiple recording. Furthermore, the data storage device may perform the shift multiple recording that page data is recorded at different positions by causing the data recording medium 200 to move in both the x-axis and the y-axis shown in FIG. 1A. In this way, data is recorded at a target position in the data recording medium 200.

Furthermore, in the first embodiment, the three-dimensional position and rotation (e.g., rotation about the y-axis) of the data recording medium 200 are controlled using the first and second reference light beams. That is, the reflected light beams of the first and second reference light beams reflected by a part of the data recording medium 200 are deflected in their optical paths by the light deflection element (also referred to as the light deflection unit) 155 and directed to the photodetector 160 arranged near the objective lens 130 as shown in FIG. 1B. The photodetector 160 transmits image information on the reflected light images of the first and second reference light beams to the arithmetic unit 170 shown in FIG. 1A.

The arithmetic unit 170 calculates positional error information on the data recording medium 200 based on image information received from the photodetector 160. The positional error information calculated by the arithmetic unit 170 is output to the drive unit 180. The drive unit 180 is connected physically to the data recording medium 200 so as to be capable of performing three-dimensional positional and rotational control of the data recording medium 200. The drive unit 180 generates a drive signal from positional error information. Alternatively, the arithmetic unit 170 may generate a drive signal according to the calculated positional error information and output the drive signal to the drive unit 180. The drive unit 180 varies the three-dimensional position and inclination of the data recording medium 200 according to the drive signal, thereby positioning the data recording medium 200 in a desired position. The way the arithmetic unit 170 calculates positional error information on the data recording medium 200 based on image information from the photodetector 160 will be described later.

When positional error information on the data recording medium 200 is calculated, the shutter 190 may intercept neither the first reference light beam nor second reference light beam, that is, the first and second reference light beams may be applied to the data recoding medium 200 simultaneously, or either the first reference light beam or second reference light beam may be always intercepted by the shutter 190 as when data is recorded. When either the first or second reference light beam is intercepted, the arithmetic unit 170 stores, in its internal memory (not shown), positional information obtained from reflected light images of the first and second reference light beams on the photodetector 160 and uses the positional information in calculating positional error information.

FIG. 1B shows the way the first and second reference light beams reflected by the half-mirror 140 and mirror 150 enter the data recording medium 200 and reflected light beams reflected by the data recording medium 200 are deflected by the light deflection element 155 and enter the photodetector 160. As shown in FIG. 1B, the first and second reference light beams reflected by the data recording medium 200 pass through different optical paths from the data light beam and enter the photodetector 160. In FIG. 1B, the first and second reference light beams are displayed on top of each other.

In the first embodiment, the light deflection element 155 is arranged on an optical path of a reflected light beam from the data recording medium 200 to the photodetector 160. As a result, an incidence angle of θ₂ of a reflected light beam to the sensor surface of the photodetector 160 is smaller than an incidence angle of θ₁ of a reflected light beam to the entrance face of the light deflection element 155. That is, θ₁>θ₂ holds. Here, the incidence angle θ₁ of a reflected light beam to the entrance face of the light deflection element 155 indicates an angle (0°<θ₁<90°) between an axis perpendicular to the entrance face of the light deflection element 155 and the reflected light beam. The incidence angle θ₂ of a reflected light beam to the sensor surface of the photodetector 160 indicates an angle (0°<θ₂<90°) between an axis perpendicular to the sensor surface of the photodetector 160 and the reflected light beam. If the incidence angle θ₂ of a reflected light beam to the sensor surface of the photodetector 160 is decreased, the cross-sectional diameter of the reflected light beam detected by the photodetector 160 decreases. As a result, it becomes easier to determine the center position (coordinates on the sensor surface explained below) of the reflected light beam detected by the photodetector 160. In addition, since the energy density of the reflected light beam incident on the photodetector 160 is improved, the detection accuracy of the reflected light beam is improved.

When the incidence angle θ₂ of a reflected light beam to the sensor surface of the photodetector 160 is large, some photodetector 160 cannot detect the reflected light beam because of structural restrictions. Therefore, the photodetector 160 is required to be capable of detecting a light beam entering the sensor surface at a large incidence angle. Therefore, in the first embodiment, the reflected light beam from the data recording medium 200 is deflected in its optical path by the light deflection element 155, thereby decreasing the incidence angle θ₂ of the reflected light beam to the sensor surface of the photodetector 160. With this setting, even such a photodetector 160 as a general-purpose CCD image sensor can detect the reflected light beam reliably.

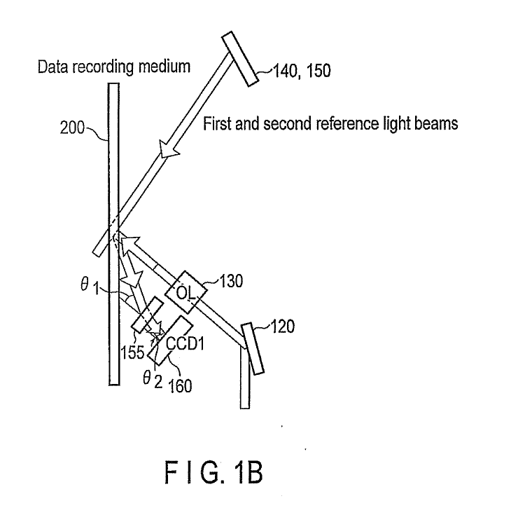

Next, the operation of reproducing data from the data recording medium 200 will be explained with reference to FIGS. 2A and 2B.

FIG. 2A schematically shows an optical system used in reproducing data in a data storage device according to the first embodiment. FIG. 2B shows a light beam trajectory related to the data recording medium 200 shown in FIG. 2A. In FIGS. 2A and 2B, the same parts and the same places are indicated by the same reference numbers as those of FIGS. 1A and 1B and an explanation of them will be omitted. The data storage device shown in FIG. 2A includes a shutter 250, a photodetector 260, a λ/4 plate 270, a reproduction mirror 290, a λ/4 plate 280, and a reproduction mirror 295 to reproduce data, in addition to the elements shown in FIG. 1A. The shutter 250 intercepts a data light beam from the polarization beam splitter 40. The photodetector 260 detects a reproduced light beam corresponding to a reproduced signal reflected by the polarization beam splitter 50. The photodetector 260 is, for example, a CCD image sensor or a CMOS image sensor. The λ/4 plate 270 and reproduction mirror 290, which are integrally formed as shown in FIG. 2B, are arranged so as to reflect a first reference light beam passing through the data recording medium 200 and direct the beam to the data recording medium 200. Similarly, the λ/4 plate 280 and reproduction mirror 295, which are integrally formed, are arranged so as to reflect a second reference light beam passing through the data recording medium 200 and direct the beam to the data recording medium 200.

As shown in FIG. 2A, laser beam from the light source 10 is split into two routes by the polarization beam splitter 40. In a reproducing operation, a data light beam reflected by the polarization beam splitter 40 is not used and therefore is intercepted by the shutter 250.

A reference light beam passing through the polarization beam splitter 40 is split into a first reference light beam and a second reference light beam, which correspond to data reproducing light beams, as in a recording operation. As shown in FIG. 2B, the first reference light beam reflected by the half-mirror 140 passes through the data recording medium 200 and further the λ/4 plate 270 and is reflected by the reproduction mirror 290. The first data light beam reflected by the reproduction mirror 290 passes through the λ/4 plate 270 again in the reverse direction and is applied to a specific position in the data recording medium 200 on which data to be read is recorded. Similarly, the second reference light beam reflected by the mirror 150 passes through the data recording medium 200 and further the λ/4 plate 280, is reflected by the reproduction mirror 295, passes through the λ/4 plate 280 again in the reverse direction, and is applied to a specific position in the data recording medium 200 on which data to be read is recorded. The optical paths of the first and second reference light beams used in creating positional error information are exactly the same as those in the recording operation explained with reference to FIG. 1B.

The first embodiment is a holographic storage device using a so-called phase conjugation reproducing method. As shown in FIG. 2B, a reflected light beam reflected by the reproduction mirror 290 or reproduction mirror 295 is applied to the data recording medium 200. As a result, a data light beam (hereinafter, referred to as a reproduced light beam) based on data recorded on the data recording medium 200 is read and enters the objective lens 130. Specifically, a reference light beam (the first or second reference light beam) is applied on an interference pattern recorded on the data recording medium 200 and a diffraction image from the interference pattern is taken out as a reproduced light beam. The reproduced light beam passing through the objective lens 130 is reflected by the raising mirror 120 in the opposition direction to that in the recording and passes through the lens 110, mirror 100, aperture 90, and lens 80 in that order as shown in FIG. 2A. The reproduced light beam passing through the lens 80 and turned into parallel light is reflected by the polarization beam splitter 50 and is incident on the photodetector 260. The photodetector 260 reproduces page data from the reproduced light beam read from the data recording medium 200.

In reproducing data, either the first or second reference light beam is always intercepted by the shutter 190. On the data recording medium 200, either the first or second reference light beam is applied to a position in the data recording medium 200 at which data to be read is recorded. That is, the irradiation of the first reference light beam causes page data recorded by the first reference light beam and data light beam to be reproduced. The irradiation of the second reference light beam causes page data recorded by the second reference light beam and data light beam to be reproduced.

In the first embodiment, laser beam is applied to almost the same position in the data recording medium 200 from two different directions and then the reflected light beams are detected, thereby enabling the three-dimensional position and posture of the data recording medium to be detected. In addition, adjusting the position and posture of the data recording medium 200 according to positional error information enables high-accuracy three-dimensional positional and rotational control.

The first embodiment is explained on the assumption that two light fluxes are applied on the data recording medium 200 from different directions and a reflected light beam from an arbitrary position on the data recording medium 200, for example, from the surface, can be detected by the photodetector 160. However, what position on the data recording medium 200 a reflected light beam comes from as a light flux detected by the photodetector 160 cannot be determined and the light amount of the reflected light beam from the surface of the data recording medium 200 is very low. To overcome these problems, servo marks that reflect the first and second reference light beams are formed in the data recording medium 200 of the first embodiment.

FIG. 3 is a sectional view of the data recording medium 200 in which servo marks are formed. As shown in FIG. 3, the data recording medium 200 includes a recording medium (also referred to as a recording layer) 400 for recording data which is interposed between a transparent substrate 410 and a transparent substrate 420. The thickness of each part is not particularly limited. For example, the thickness of each of the transparent substrates 410 and 420 is 0.5 mm. The thickness of the recording medium 400 is 1.0 mm. On the surface of the transparent substrate 420 on the recording medium 400 side, that is, on the interface between the recording medium 400 and transparent substrate 420, a servo mark layer 430 is formed. In the servo mark layer 430, a plurality of servo marks 431 that reflect the first and second reference light beams are formed. The planar shape of the data recording medium 200, that is, the shape of the data recording medium 200 viewed from arrow A of FIG. 3, is a round shape with a diameter of, for example, 12 cm as shown in FIGS. 1 and 2.

The servo mark layer 430 may be formed on the interface between the transparent substrate 410 and recording medium 400. In this case, too, the same effect is produced. The data recording medium is not limited to a round shape as shown in FIGS. 1A and 2A and may be formed into an arbitrary shape, such as a square shape, a rectangle shape, an ellipse shape, or another polygonal shape.

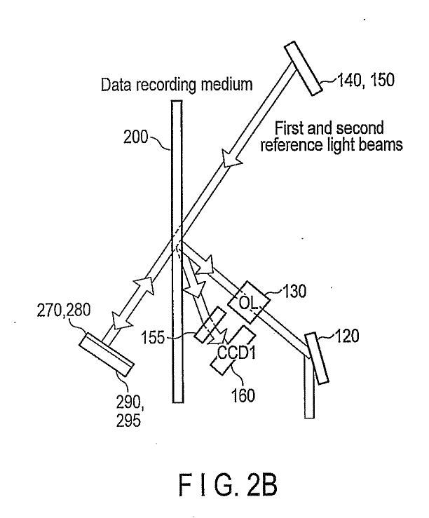

FIG. 4 shows trajectories of reflected light beams reflected by servo marks in the data recording medium 200. In the first embodiment, as shown in FIG. 4, the first and second reference light beams enter the surface of the lower transparent substrate 410, pass through the recording medium 400, and are applied to almost the same position of the servo mark layer 430. Then, a part of the applied light beam (at least one of the first and second reference light beams) is reflected by the servo marks 431 formed in the servo mark layer 430. The reflected light beam passes through the recording medium 400 and transparent substrate 410 in that order and enters the light deflection element 155. The reflected light beam whose optical path is deflected by the light deflection element 155 enters the sensor surface of the photodetector 160. The servo marks 431 are such that, for example, minute marks formed of an aluminium thin film or a silver alloy thin film are recorded at specific intervals. The servo marks 431 are made of a material that reflects the first and second reference light beams at a reflectance of 80% or more, for example.

In the example of FIG. 4, round servo marks 431 are arranged at specific intervals along the x-axis. The diameter of a servo mark 431 is, for example, 50 μm. The specific interval d is, for example, 1.0 mm. Each of the first and second reference light beams has almost the same cross-section diameter and captures servo marks 431 in an applied light flux in the servo mark layer 430. For example, when the first and second reference light beams capture two servo marks 431 in their light fluxes at the same time, reflected light beams from the servo marks 431 amount to four reflected light beams, two from the first reference light beam and two from the second reference light beam. The four reflected light beams enter the sensor surface of the photodetector 160.

[Calculating Three-Dimensional Positional Error Information]

Next, a method of calculating three-dimensional positional error information will be explained in concrete terms using reflected light beams from servo marks 431 formed in the data recording medium 200.

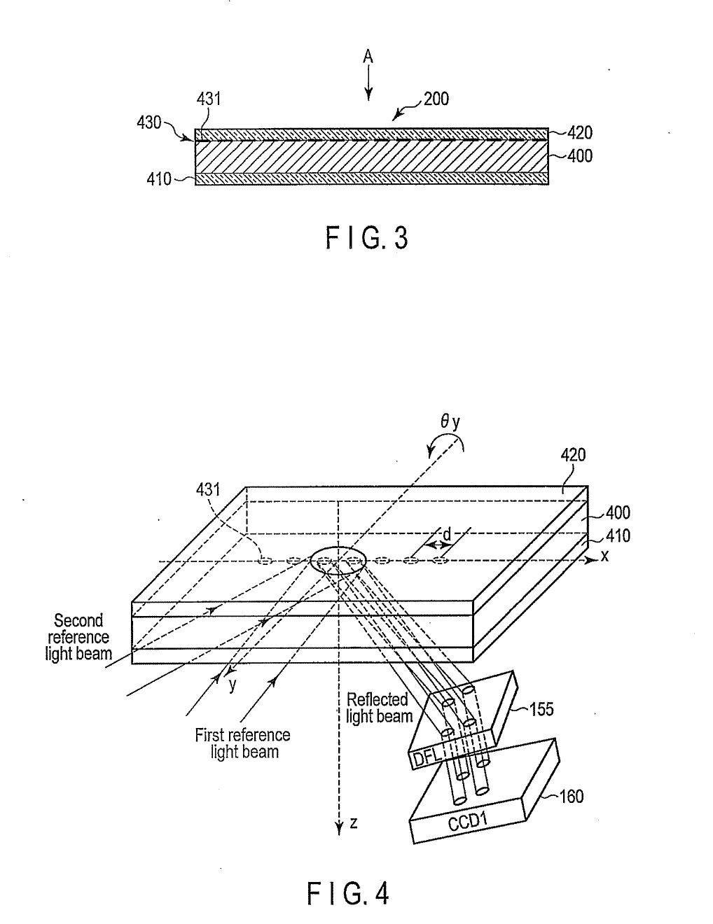

FIG. 5 shows an optical system for detecting a reflected light beam, which includes a prism 155 having a shape of triangular prism as a light deflection element. In FIG. 5, for ease of explanation, the data recording medium 200 is simplified. As shown in FIG. 5, coordinate axes x, y, z are set in the data recording medium 200. Specifically, with a reference position in which a specific servo mark is to be positioned as the origin, the x-axis and y-axis are set in the directions in which the medium extends (i.e., in-plane directions) and the z-axis is set in the direction of thickness of the medium 200. The data recording medium 200 is a holographic storage medium where angle multiple recording is performed in the rotation (θy) direction about the y-axis and shift multiple recording is performed in the x-axis and y-axis directions. For ease of explanation, FIG. 5 shows a case where servo mark 431a is at the origin and servo mark 431b is at a known specific distance of d from the origin in the x-direction.

Positional error information indicates a shift length of a specific servo mark (e.g., servo mark 431a) from a reference position (i.e., the origin of the x-y-x coordinate system). In the first embodiment, the position and posture of the data recording medium 200 are adjusted so as to bring a specific servo mark close to the reference position according to positional error information calculated at the arithmetic unit 170.

In the first embodiment, let a plane including the entrance face (slope face) of the prism 155 be a u-v plane. The u-v plane, the entrance face, coincides with a plane obtained by translating the x-y plane of the data recording medium 200 by a specific distance of dz in the z-axis direction and then rotating the resulting x-y plane by a specific angle of αy about the y-axis. Here, as for the rotation about the y-axis, the positive direction of the y-axis is set in the direction in which a right-hand screw advances and the direction in which a right-hand screw rotates is set as positive.

In the first embodiment, let a distance of dz in the z-axis direction be 12 mm and a rotation angle of αy about the y-axis be −10 degrees. The prism 155 is so formed that its vertex angle β is 20 degrees. The emitting surface (bottom surface) of the prism and the sensor surface of the photodetector 160 are arranged parallel to each other. Let the distance between the emitting surface and the sensor surface be 6.0 mm. In addition, a plane including the sensor surface of the photodetector 160 is set in an s-t plane that has an s-axis and a t-axis. For simplicity, in FIG. 5, suppose the data recording medium 200 is such that the transparent substrate 410 and recording medium 400 of FIG. 3 are integrally formed and its thickness is set to 1.5 mm. In FIG. 5, the transparent substrate 420 is not shown. In addition, as for the incidence angles of the first and second reference light beams, a rotation angle about the y-axis is 51.6 degrees; a rotation angle about the z-axis is −37.5 degrees for the first reference light beam and 37.5 degrees for the second reference light beam.

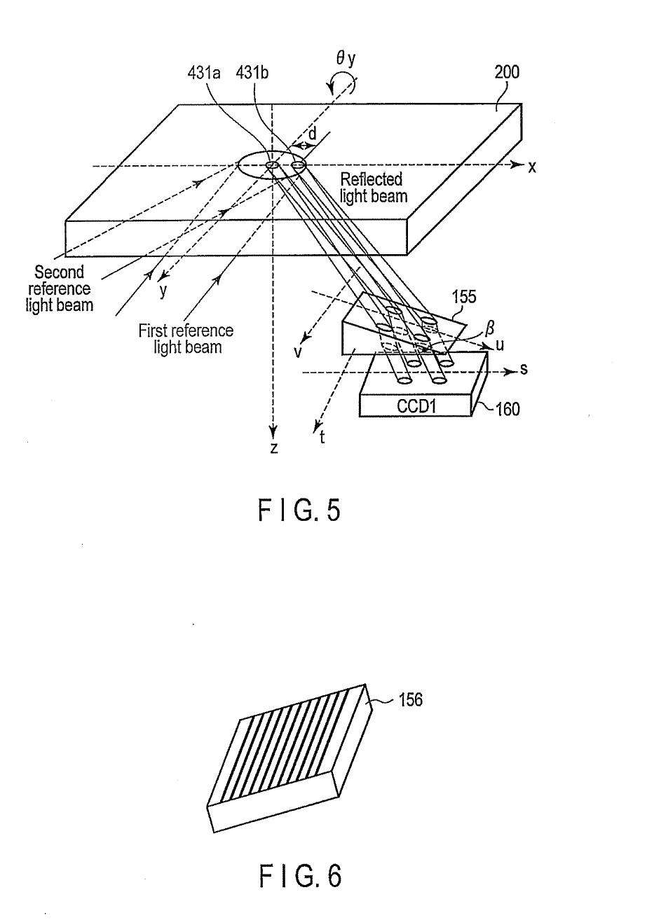

The light deflection element 155 is not limited to an example of the prism that transmits a light flux and deflects the flux as shown in FIG. 5 and may be, for example, a diffraction element that diffracts light. A diffraction element functioning as the light deflection element 155 is such that a diffraction grating pattern is provided on, for example, a rectangular substrate as shown in FIG. 6.

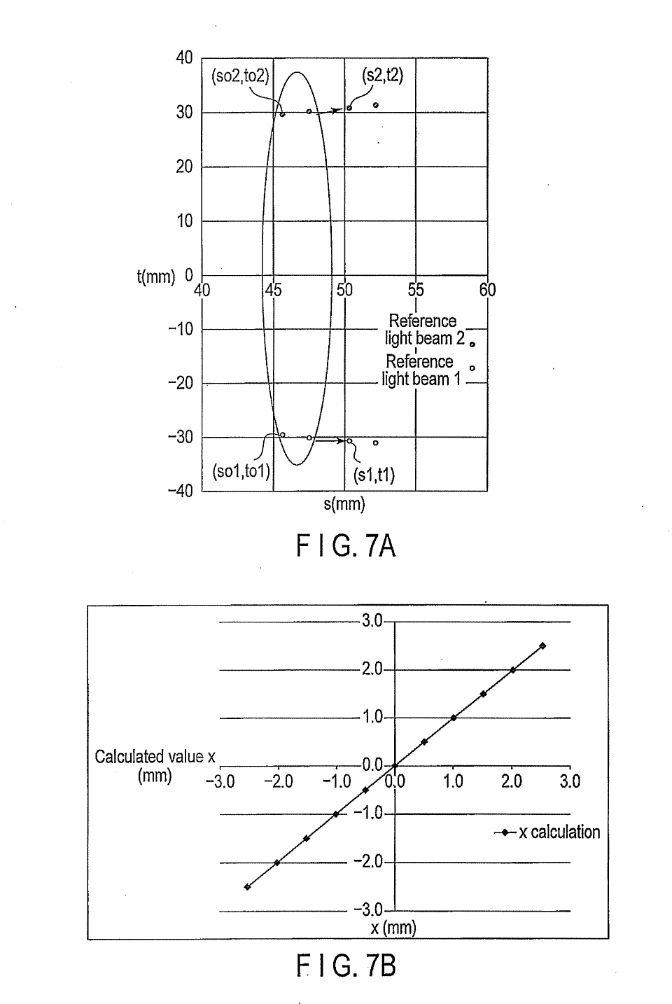

Next, the process of calculating three-dimensional positional error information and positioning drive control of the data recording medium 200 according to the calculated positional error information will be explained with reference to FIGS. 7A to 10B.

In the first embodiment, suppose a state where servo mark 431a is at the origin (reference position) of the x-y-z coordinates and the data recording medium 200 inclines at an angle of 10 degrees about the y-axis is the initial position of the data recording medium 200. When the entrance face of the aforementioned prism 155 is set at θy=−10 degrees, the relative angle between the data recording medium 200 in the initial position and the entrance face of the prism 155 is at 20 degrees. The process of calculating positional error information in the first embodiment is to detect the coordinate position of the center position of reflected spot images from servo marks 431a, 431b on the sensor surface of the photodetector 160 and calculate a displacement and a rotation amount for the data recording medium 200 to move from the coordinate positions of a plurality of reflected spot images to the initial position.

[Calculating Positional Error Information in the X-direction]

A method of calculating positional error information in the x-direction will be explained with reference to FIGS. 7A and 7B.

FIG. 7A shows the center position of reflected spot images from servo marks 431a and 431b when the data recording medium 200 is displaced from the initial position in the x-direction. FIG. 7B is a graph plotting the relationship between the displacement amount in the x-direction of the data recording medium 200 (on the transverse axis) and a positional error information calculated value in the x-direction calculated using Equation (1) described later (on the vertical axis).

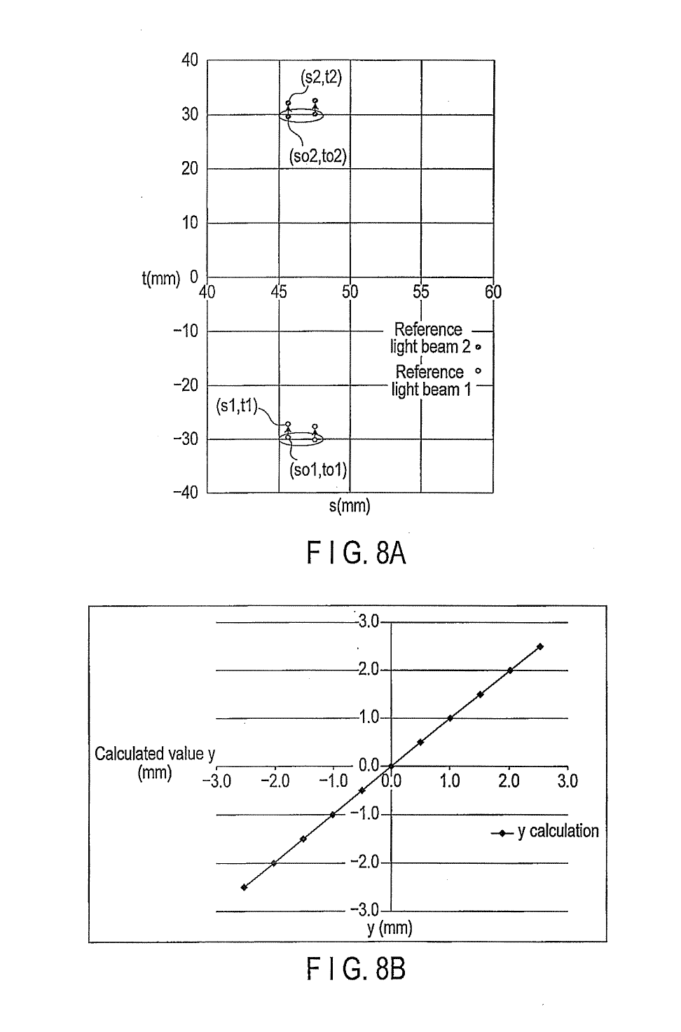

FIG. 7A shows the center positions (enclosed by an ellipse) of reflected spot images from servo marks 431a and 431b when the data recording medium 200 is arranged in the initial position and the center positions of reflected spot images from servo marks 431a and 431b when the data recording medium 200 is displaced 2.5 mm from the initial position in the x-direction. FIG. 7B shows positional error information calculated values obtained by displacing the data recording medium 200 in a range of ±2.5 mm from the initial position in the x-direction. FIGS. 7A and 7B show the result of running a geometric simulation of incident light and reflected light based on the mechanical conditions, including the thickness and angle of the data recording medium 200 as described above, and incidence conditions for incident light. Hereinafter, the same holds true for FIGS. 8A to 10B.

Let the coordinates of a reflected spot image from servo mark 431a by the first reference light beam be (S1, t1). The coordinates of the reflected spot image indicate the center position of a reflected light image from a servo mark on the sensor surface (i.e., the s-t plane) of the photodetector 160. In addition, let the coordinates of a reflected spot image from servo mark 431a by the second reference light beam be (s2, t2). Moreover, let the initial coordinates of a reflected spot image from servo mark 431a by the first reference light beam be (so1, to1). Here, the initial coordinates of a reflected spot image indicate the coordinates of a reflected spot image from a servo mark positioned in the reference position (origin) when the data recording medium 200 is arranged in the initial position. In addition, let the initial coordinates of a reflected spot image from servo mark 431a by the second reference light beam be (so2, to2). Moreover, let an increment in the distance between the coordinates of reflected spot images from servo marks 431a and 431b by the first reference light beam with respect to the distance between their initial coordinates be Δs1 (the s direction), Δt1 (the t direction). In addition, let an increment in the distance between the coordinates of reflected spot images from servo marks 431a and 431b by the second reference light beam with respect to the distance between their initial coordinates be Δs2 (the s direction), Δt2 (the t direction). At this time, displacement x in the x-direction of servo mark 431a is given by:

x=A{(s1−so1+s2−so2)−B(to1−t1+t2−to2)−C(Δs1+Δs2+Δt1+Δt2)}, (1)

where A, B, C are constants. The result of the aforementioned simulation run by the inventor has shown that setting A=0.452, B=1.667, and C=3.718 causes the displacement in the x-direction of the data recording medium 200 and the result of performing computation using Equation (1) to have the characteristic shown in FIG. 7B. That is, as a result of setting parameters A, B, and C suitably, an actual displacement amount in the x-direction of the data recording medium 200 and the calculated values obtained from Equation (1) have a substantial proportional relation with a proportional constant of k=1.

As can be seen from FIG. 7B, the result of calculating positional error information using Equation (1) replicates the displacement in the x-direction of the data recording medium 200 accurately. Therefore, the data recording medium 200 is moved in the x-direction so as to give calculation result x=0 based on the result of calculating the positional error information, enabling servo mark 431a in the data recording medium 200 to be directed to the reference position accurately. That is, the arithmetic unit 170 does calculations using Equation (1) and the result of calculating positional error information is supplied to the drive unit 180. The drive unit 180 performs movement control of the data recording medium 200 so as to direct servo mark 431a to the reference position.

[Calculating Positional Error Information in the Y-Direction]

Next, a method of calculating positional error information in the y-direction will be explained with reference to FIGS. 8A and 8B.

FIG. 8A shows the center positions of reflected spot images from servo marks 431a and 431b when the data recording medium 200 is displaced from the initial position in the y-direction. FIG. 8B is a graph plotting the relationship between the displacement amount in the y-direction of the data recording medium 200 (on the transverse axis) and a positional error information calculated value in the y-direction calculated using Equation (2) described later (on the vertical axis).

FIG. 8A shows the center positions (enclosed by an ellipse) of reflected spot images from servo marks 431a and 431b when the data recording medium 200 is arranged in the initial position and the center positions of reflected spot images from servo marks 431a and 431b when the data recording medium 200 is displaced 2.5 mm from the initial position in the y-direction. FIG. 8B shows positional error information calculated values obtained by displacing the data recording medium 200 in a range of ±2.5 mm from the initial position in the y-direction.

In FIG. 8A, let the coordinates of a reflected spot image from servo mark 431a by the first reference light beam be (s1, t1). In addition, let the coordinates of a reflected spot image from servo mark 431a by the second reference light beam be (s2, t2). Moreover, let the initial coordinates of a reflected spot image from servo mark 431a by the first reference light beam be (so1, to1). In addition, let the initial coordinates of a reflected spot image from servo mark 431a by the second reference light beam be (so2, to 2). At this time, displacement y in the y-direction of servo mark 431a is given by:

y=D{(t1−to1+t2−to2)−E(s1−so1−s2+so2)}, (2)

where D and E are constants. The result of running the aforementioned simulation shows that setting D=0.50 and E=1.09 causes the displacement in the y-direction and the result of performing computation using Equation (2) to have the characteristic shown in FIG. 8B. That is, as a result of setting parameters D and E suitably, an actual displacement amount in the y-direction of the data recording medium 200 and the calculated values obtained from Equation (2) have a substantial proportional relation with a proportional constant of k=1.

As can be seen from FIG. 8B, the result of calculating positional error information using Equation (2) replicates the displacement in the y-direction of the data recording medium 200 accurately. Therefore, the data recording medium 200 is moved in the y-direction so as to give calculation result y=0 based on the result of calculating the positional error information, enabling servo mark 431a in the data recording medium 200 to be directed to the reference position accurately. Similarly, the arithmetic device 170 does calculations using Equation (2). The result of calculating positional error information is supplied to the drive unit 180. The drive unit 180 performs movement control of the data recording medium 200 so as to direct servo mark 431a to the reference position.

[Calculating Positional Error Information in the Z-Direction]

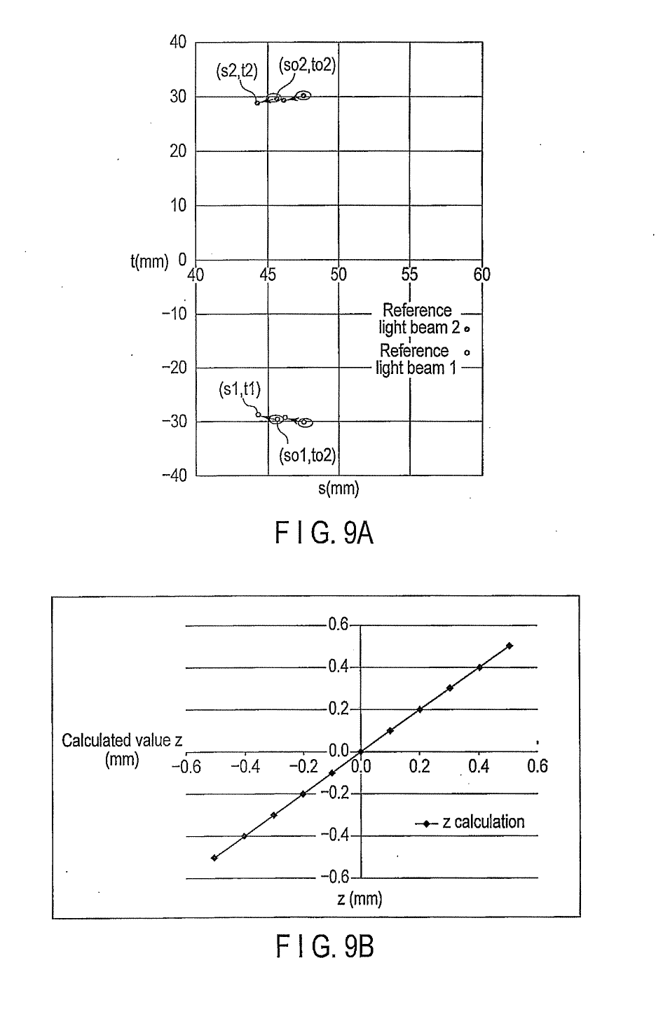

Next, a method of calculating positional error information in the z-direction will be explained with reference to FIGS. 9A and 9B.

FIG. 9A shows the center positions of reflected spot images from servo marks 431a and 431b when the data recording medium 200 is displaced from the initial position in the z-direction. FIG. 9B is a graph plotting the relationship between the displacement amount in the y-direction of the data recording medium 200 (on the transverse axis) and a positional error information calculated value in the z-direction calculated using Equation (3) described later (on the vertical axis).

FIG. 9A shows the center positions (enclosed by an ellipse) of reflected spot images from servo marks 431a and 431b when the data recording medium 200 is arranged in the initial position and the center positions of reflected spot images from servo marks 431a and 431b when the data recording medium 200 is displaced 0.5 mm from the initial position in the z-direction. FIG. 9B shows positional error information calculated values obtained by displacing the data recording medium 200 in a range of ±0.5 mm from the initial position in the z-direction.

In FIG. 9A, let the coordinates of a reflected spot image from servo mark 431a by the first reference light beam be (s1, t1). In addition, let the coordinates of a reflected spot image from servo mark 431a by the second reference light beam be (s2, t2). Moreover, let the initial coordinates of a reflected spot image from servo mark 431a by the first reference light beam be (so1, to1). In addition, let the initial coordinates of a reflected spot image from servo mark 431a by the second reference light beam be (so2, to2). At this time, displacement z in the z-direction of servo mark 431a is given by:

z=F{(s1−so1+s2−so2)−G(to1−t1+t2−to2)}, (3)

where F and G are constants. Similarly, the result of running the aforementioned simulation shows that setting F=0.72 and G=2.1 causes the displacement in the z-direction and the result of performing computation using Equation (3) to have the characteristic shown in FIG. 9B. That is, as a result of setting parameters F and G suitably, an actual displacement amount in the z-direction of the data recording medium 200 and the calculated values obtained from Equation (3) have a substantial proportional relation with a proportional constant of k=1.

As can be seen from FIG. 9B, the result of calculating positional error information using Equation (3) replicates the displacement in the z-direction of the data recording medium 200 accurately. Therefore, the data recording medium 200 is moved in the z-direction so as to give calculation result z=0 based on the result of calculating the positional error information, enabling servo mark 431a on the data recording medium 200 to be directed to the reference position accurately. Similarly, the arithmetic device 170 does calculations using Equation (3). The result of calculating positional error information is supplied to the drive unit 180. The drive unit 180 performs movement control of the data recording medium 200 so as to direct servo mark 431a to the reference position.

[Calculating Positional Error Information in the θy Direction]

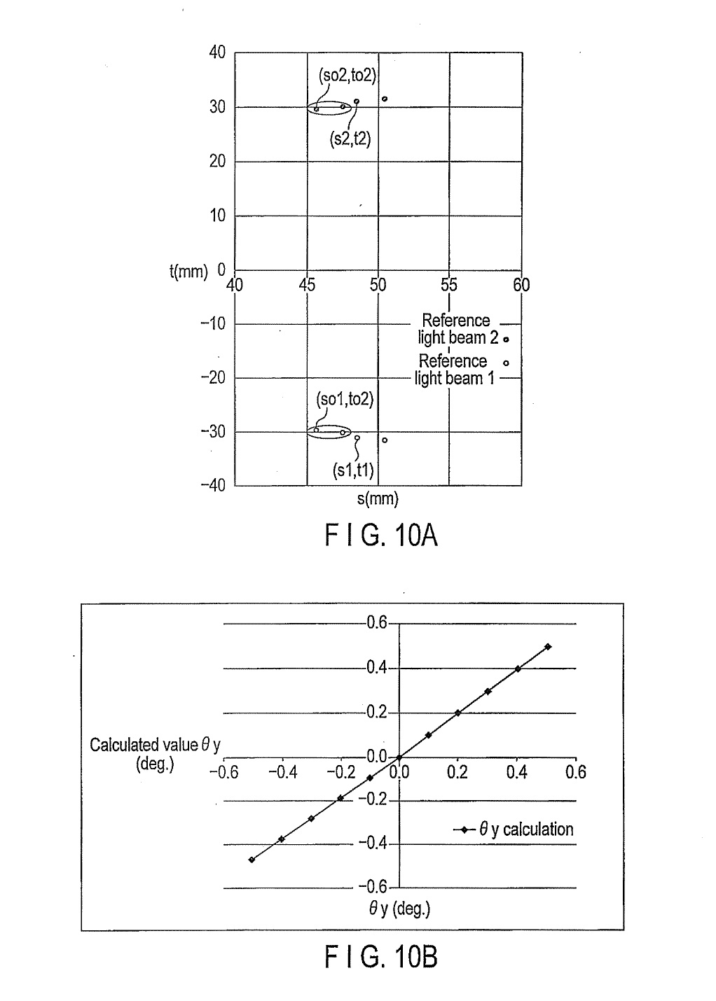

Next, a method of calculating positional error information in the θy direction will be explained with reference to FIGS. 10A and 10B.

FIG. 10A shows the center positions of reflected spot images from servo marks 431a and 431b when the data recording medium 200 is rotated from the initial position in the θy direction. FIG. 10B is a graph plotting the relationship between the rotation amount in the θy direction of the data recording medium 200 (on the transverse axis), and a positional error information calculated value in the θy direction calculated using Equation (4) described later (on the vertical axis).

FIG. 10A shows the center positions (enclosed by an ellipse) of reflected spot images from servo marks 431a and 431b when the data recording medium 200 is arranged in the initial position and the center positions of reflected spot images from servo marks 431a and 431b when the data recording medium 200 is rotated 0.5 degrees from the initial position in the θy direction. FIG. 10B shows positional error information calculated values obtained by rotating the data recording medium 200 in a range of ±0.5 degrees from the initial position in the θy direction.

In FIG. 10A, let the coordinates of a reflected spot image from servo mark 431a by the first reference light beam be (s1, t1). In addition, let the coordinates of a reflected spot image from servo mark 431a by the second reference light beam be (s2, t2). Moreover, let the initial coordinates of a reflected spot image from servo mark 431a by the first reference light beam be (so1, to1). In addition, let the initial coordinates of a reflected spot image from servo mark 431a by the second reference light beam be (so2, to2). At this time, displacement θy in the θy direction of servo mark 431a is given by:

θy=H{(s1−so1+s2−so2)−I(to1−t1+t2−to2)}, (4)

where H and I are constants. Similarly, the result of running the aforementioned simulation shows that setting H=0.44 and G=1.667 causes the displacement in the θy direction and the result of performing computation using Equation (4) to have the characteristic shown in FIG. 10B. That is, as a result of setting parameters H and I suitably, an actual displacement amount in the θy direction of the data recording medium 200 and the calculated values obtained from Equation (4) have a substantial proportional relation with a proportional constant of k=1.

As can be seen from FIG. 10B, the result of calculating positional error information using Equation (4) replicates the rotation in the θy direction of the data recording medium 200 accurately. Therefore, the data recording medium 200 is rotated in the θy direction so as to give calculation result θy=0 based on the result of calculating the positional error information, enabling servo mark 431a on the data recording medium 200 to be directed to the reference position accurately. Similarly, the arithmetic unit 170 does calculations using Equation (4) and the result of calculating positional error information is supplied to the drive unit 180. The drive unit 180 performs rotation control of the data recording medium 200 so as to direct servo mark 431a to the reference position.

In the first embodiment, the data recording medium 200 is adjusted to a desired position and posture by combining positional control in the three axis directions and rotation control about the single axis as described above.

While in the method of calculating positional error information, reflected light beams from two servo marks are detected, the embodiment is not limited to this. Positional error information may be calculated using reflected beams from one or not less than two servo marks. For example, when each of the first and second reference light beams captures a servo mark in its light flux, the photodetector 160 detects a total of two reflected spot images. In an example where each of the first and second reference light beams captures a servo mark in its light flux, it is satisfactory if Δs1=Δs2=Δt1=Δt2=0 in Equation (1), with the result that calculations become easy, though the accuracy deteriorates. When strict positional control is required as in a holographic storage device, it is desirable that positional error information should be calculated using reflected light beams from a plurality of servo marks from a viewpoint of the accuracy of positional information.

As described above, with the data storage device according to the first embodiment, three-dimensional positional information on a data recording medium can be calculated by irradiating almost the same position on a data recording medium with laser beam from two different directions and detecting the reflected light beams. In addition, high-accuracy three-dimensional positional and rotational control can be performed by adjusting the three-dimensional position of the data recording medium based on the positional information.

### Second Embodiment

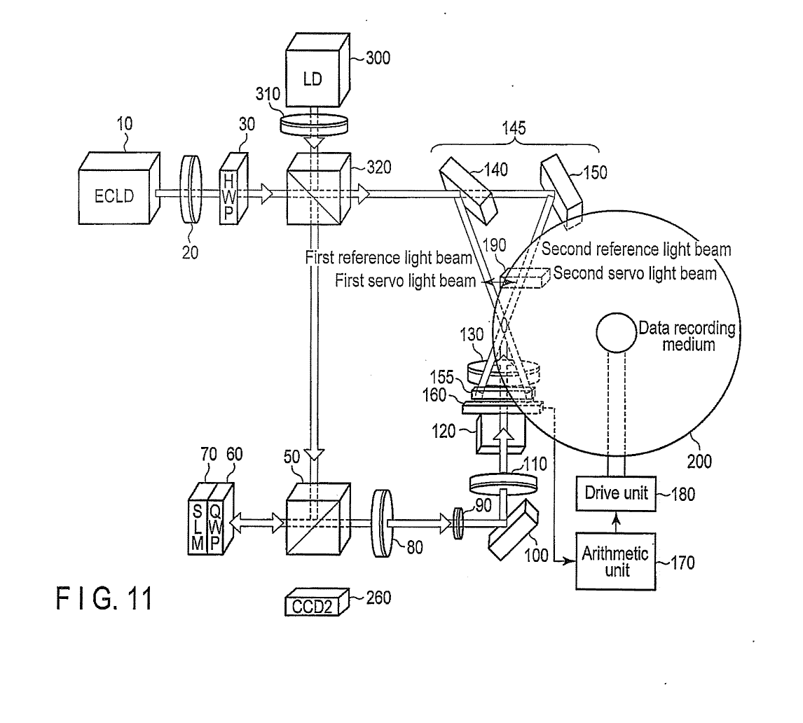

FIG. 11 shows an optical system used in recording data in a data storage device according to a second embodiment. In FIG. 11, the same parts and places are indicated by the same reference numbers as those in FIG. 1A and an explanation of them will be omitted. As shown in FIG. 11, the data storage device of the second embodiment includes two light sources, a first light source that generates a first light beam (light beam for servo control) related to the creation of positional error information on the data recording medium 200 and a second light source 10 that generates a second light beam used in recording and reproducing data. The first light source 300 is, for example, a semiconductor laser (LD) that emits laser beam whose wavelength differs from that of a second light beam generated by the second light source 10.

The data storage device of FIG. 11 further includes a collimator lens 310 that collimates laser beam from the first light source 300. In addition, the data storage device of FIG. 11 is provided with a dichroic polarization beam splitter (PBS) 320 in place of the polarization beam splitter 40 shown in FIG. 1A.

As an example, FIG. 11 shows an arrangement in recording data on a data recording medium 200. When data is reproduced from the data recording medium 200, the paths, elements, arithmetic operation, and driving operation related to the creation of positional error information explained below are similar to those in recording data.

A second laser beam emitted from the second light source (ECLD) 10 of FIG. 11, for example, a laser beam with a center wavelength of 405 nm, passes through a collimator lens 20 and a λ/2 plate 30 and enters the dichroic polarization beam splitter 320. A first laser beam from the first light source 300 differing in wavelength from the second light source 10 is collimated by the collimator lens 310. The collimated first laser beam enters the dichroic polarization beam splitter 320. The first light source 300 emits light with a wavelength of, for example, 650 nm which belongs to a red wavelength range.

The optical branching face (slope face) inside the dichroic polarization beam splitter 320 always reflects the first laser beam with a 650-nm wavelength from the first light source 300. The dichroic polarization beam splitter 320 has the property of transmitting a P-polarized component of the first laser beam with a 405-nm wavelength from the light source 10 and reflecting an S-polarized component thereof. Therefore, the first laser beam from the first light source 300 is reflected by the dichroic polarization beam splitter 320 and directed to a half-mirror 140. The second laser beam from the second light source 10 is split by the dichroic polarization beam splitter 320 into two routes (so as to transmit a P-polarized component and reflect an S-polarized component). The S-polarized component serves as a data light beam and the P-polarized component serves as a first and a second reference light beam. Since the optical paths of the data light beam and the first and second reference light beams from this point on are the same as those of the first embodiment, an explanation of them will be omitted.

The first laser beam from the first light source 300 is divided by the half-mirror 140 into a first servo light beam reflected by the half-mirror 140 and a second servo light beam passing through the half-mirror 140. The first servo light beam passes through the same optical path as that of the first reference light beam. The second servo light beam passes through the same optical path as that of the second reference light beam. Therefore, the first and second servo light beams are applied at different angles to almost the same position in the data recording medium 200 at which the data light beam focuses. The recording of data on the data recording medium 200 is realized by the first and second reference light beams and data light beam. The first and second servo light beams make no contribution to recording (and reproducing) data on (from) the data recording medium 200.

Next, three-dimensional positional and rotational control in the second embodiment will be explained. To perform three-dimensional positional and rotational control, at least a spatial part of the first and second servo light beams are reflected by the data recording medium 200. The reflected light beam is deflected in its optical path by a light deflection element (DFL) 155 and detected by a photodetector 160 arranged near an objective lens 130. The photodetector 160 is, for example, a CCD sensor that includes a plurality of solid-state image sensors arranged in rows and columns.

The photodetector 160 transmits image information on reflected light images of the first and second servo light beams to an arithmetic unit 170. The arithmetic unit 170 calculates positional error information on the data recording medium based on the image information and outputs the error information to a drive unit 180. The drive unit 180 is connected physically to the data recording medium 200 so as to be capable of performing three-dimensional positional and rotational control of the data recording medium 200. In addition, based on a drive signal generated from positional error information, the drive unit 180 adjusts three-dimensional position and inclination of the data recording medium 200 so as to position the data recording medium 200 in a desired position.

In calculating positional error information on the data recording medium 200, neither the first nor second servo light beam may be intercepted by a shutter 190. The first and second servo light beams may be reflected by the data recording medium 200 at the same time. Alternatively, either the first or second servo light beam may be always intercepted by the shutter 190. When either the first or second servo light beam is intercepted, positional information on reflected light images by the first and second servo beams is detected by the photodetector 160 and stored in an internal memory of the arithmetic unit 170. Thereafter, the stored positional information is used in calculating positional error information.

The shutter 190 may be made of a material that transmits the wavelengths of the first and second servo light beams and reflects or absorbs the wavelengths of the first and second reference light beams. In this case, the first and second servo light beams are always applied to the data recording medium 200 at the same time, regardless of whether the reference light beams are intercepted by the shutter 190. Therefore, there is no need to particularly store positional information on the reflected light images on the photodetector 160 in the internal memory of the arithmetic unit 170.

In the second embodiment, use of a light beam with a wavelength differing from that used in recording and reproducing as a servo light beam makes it possible to avoid useless exposure of the data recording medium 200 to the servo light beam. In this case, useless exposure means that the medium reacts with light irradiation making no contribution to recording data on the data recording medium 200, consuming the recording dynamic range of the data recording medium 200.

The configuration of the data recording medium 200 of the second embodiment is the same as that shown in FIG. 3 and therefore its explanation will be omitted. However, in the servo mark layer 430 of FIG. 3, servo marks 431 that reflect the first and second servo light beams are formed.

The relationship between servo marks and reflected light beams in the second embodiment is shown in FIGS. 4 and 5 as in the first embodiment. In this case, the first and second reference light beams shown in FIGS. 4 and 5 are replaced with the first and second servo light beams, respectively. In the second embodiment, in FIG. 4, the first and second servo light beams enter the surface of the lower transparent substrate 410, pass through the recording medium 400, and be applied to almost the same position of the servo mark layer 430. Then, a part of the applied light fluxes are reflected by the servo marks 431 formed in the servo mark layer 430. The reflected light beams pass through the recording medium 400 and transparent substrate 410 in that order and enter the sensor surface of the photodetector 160 via the light deflection element 155.

In the second embodiment, for example, a dielectric reflective film that transmits a light beam in a blue-violet wavelength range and reflects a light beam in a red wavelength range is formed as the servo marks 431 in the serve mark layer 430. In this case, the servo marks 431 reflect the first and second servo light beams at a reflectance of, for example, 80% or more and transmit the first and second reference light beams at a transmittance of, for example, 95% or more. That is, forming the servo marks 431 out of a material that reflects only the servo light beams and transmits the reference light beams enables the servo marks to be arranged in arbitrary positions in the data recording medium 200 without affecting the reproduction of data. Of course, the servo'marks 431 may be configured to reflect both of the blue-violet wavelength range and the red wavelength range. In this case, an effect on the reproduction of data can be avoided by recording no data immediately below the servo mark.

In calculating three-dimensional positional error information in the second embodiment, FIGS. 7A to 10B can be applied directly.

In the second embodiment, let the coordinates of a reflected spot image from servo mark 431a by the first servo light beam be (s1, t1). In addition, let the coordinates of a reflected spot image from servo mark 431a by the second servo light beam be (s2, t2). Moreover, let the initial coordinates of a reflected spot image from servo mark 431a by the first servo light beam be (so1, to1). In addition, let the initial coordinates of a reflected spot image from servo mark 431a by the second servo light beam be (so2, to2). Moreover, let an increment in the distance between the coordinates of reflected spot images from servo marks 431a and 431b by the first servo light beam with respect to the distance between their initial coordinates be Δs1 (the s direction), Δt1 (the t direction). In addition, let an increment in the distance between the coordinates of reflected spot images from servo marks 431a and 431b by the second servo light beam with respect to the distance between their initial coordinates be Δs2 (the s direction), Δt2 (the t direction).

[Calculating Positional Error Information in the X-Direction]

The displacement amount x of servo mark 431a along the x-axis can be found using Equation (1). The data recording medium 200 is moved in the x-direction so as to give calculation result x=0 based on the result of calculating the positional error information, enabling servo mark 431a in the data recording medium 200 to be directed to the reference position accurately.

[Calculating Positional Error Information in the Y-Direction]

The displacement amount y of servo mark 431a along the y-axis can be found using Equation (2). The data recording medium 200 is moved in the y-direction so as to give calculation result y=0 based on the result of calculating the positional error information, enabling servo mark 431a in the data recording medium 200 to be directed to the reference position accurately.

[Calculating Positional Error Information in the Z-Direction]

The displacement amount z of servo mark 431a along the z-axis can be found using Equation (3). The data recording medium 200 is moved in the z-direction so as to give calculation result z=0 based on the result of calculating the positional error information; enabling servo mark 431a in the data recording medium 200 to be directed to the reference position accurately.

[Calculating Positional Error Information in the θy Direction]

The rotation angle θy of servo mark 431a about the y-axis can be found using Equation (4). The data recording medium 200 is rotated in the θy direction so as to give calculation result θy=0 based on the result of calculating the positional error information, enabling servo mark 431a in the data recording medium 200 to be directed to the reference position accurately.

While in the second embodiment, a light beam from a single light source is split to create two servo light beams, the second embodiment is not limited to this. For example, each of two light sources whose wavelengths are almost the same may generate a servo light beam. Even when each of the two light sources emits a servo light beam, the same effect as described above can be expected.

As described above, with the data storage device according to the second embodiment, using light beams whose wavelengths differ from those of the light beams used in recording and reproducing as servo light beams makes it possible to avoid useless exposure of the data recording medium to the servo light beams. In addition, forming servo marks out of a material that reflects the servo light beams and transmits the reference light beams enables the servo marks to be arranged in arbitrary positions on the data recording medium without affecting the reproduction of data.

According to at least one of the aforementioned embodiments, the three-dimensional position of a data recording medium can be controlled with high accuracy.

Each of the aforementioned embodiments can be applied to a device that requires three-dimensional positional control, for example, to a holographic storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage device comprising:
a data recording medium;
a first light source configured to generate a first laser beam;
a light application unit configured to split the first laser beam into a first light beam and a second light beam, and apply the first light beam and the second light beam to the data recording medium from different directions;
a light detection unit configured to detect reflected light beams to generate a detection signal, the reflected light beams corresponding to the first light beam and the second light beam reflected by the data recording medium;
a light deflection unit arranged in optical paths of the reflected light beams from the data recording medium to the light detection unit, and configured to deflect the reflected light beams to direct the reflected light beams to the light detection unit;
a arithmetic unit configured to calculate positional error information indicating a relative position and posture of the data recording medium with respect to a target position and posture based on the detection signal; and
a drive unit configured to displace a position and a posture of the data recording medium based on the positional error information.

2. The device according to claim 1, wherein the data recording medium is a holographic storage medium, and the first light beam and the second light beam are reference light beams used for recording and reproducing of the holographic storage medium.

3. The device according to claim 1, further comprising a second light source configured to generate a second laser beam whose wavelength is different from a wavelength of the first laser beam, wherein
the data recording medium is a holographic storage medium,
the second laser beam is a reference light beam used for recording and reproducing of the holographic storage medium and split into a third light beam and a fourth light beam by the light application unit, and
the third light beam and the fourth light beam are applied to the data recording medium along optical paths corresponding to optical paths of the first light beam and the second light beam, respectively.

4. The device according to claim 1, wherein the detection signal includes coordinate information on the reflected light beams on a sensor surface of the light detection unit, and the arithmetic unit calculates positional error information on the data recording medium based on the coordinate information.

5. The device according to claim 1, wherein the data recording medium includes servo marks to reflect the first light beam and the second light beam.

6. The device according to claim 5, wherein the servo marks are formed in a direction in which the data recording medium is subjected to shift multiple recording.

7. The device according to claim 5, wherein the servo marks are formed at specific intervals in a direction in which the data recording medium is subjected to shift multiple recording.

8. The device according to claim 1, wherein the light deflection unit is a prism, and the reflected light beams pass through the prism.

9. The device according to claim 1, wherein the light deflection unit is a diffraction element, and the reflected light beams are diffracted by the diffraction element.

10. The device according to claim 1, wherein incidence angles of the reflected light beams to the light deflection unit is larger than incidence angles of the reflected light beams to the light detection unit.
